(19) United States
(12) Patent Application Publication
(10) Pub. No.: US 2014/0073731 A1
(43) Pub. Date: Mar. 13, 2014

(54) HIGH IMPACT POLYPROPYLENE COMPOSITIONS

(71) Applicant: Kapil Inamdar, Downingtown, PA (US)

(72) Inventor: Kapil Inamdar, Downingtown, PA (US)

(21) Appl. No.: 13/612,083

(22) Filed: Sep. 12, 2012

(51) Int. Cl. C08L 23/12; C08L 23/08; C08L 23/14

(52) U.S. Cl. 524/528

(57) ABSTRACT

Disclosed are fiber reinforced thermoplastic compositions exhibiting rigidity and improved impact resistance. The disclosed compositions comprise a polypropylene polymer component; a low melt flow elastomer component; and a fiber reinforcement component. Also disclosed are method for the manufacture of the disclosed compositions and various methods for the use thereof.

### BACKGROUND

1. Technical Field

The present disclosure relates to fiber reinforced thermoplastic polymer compositions having rigidity and improved impact resistance.

2. Technical Background

Long fiber reinforcements in thermoplastic resin can be used to improve impact properties of a formed composite resin part. However, the presence of long fibers in the composite part can also result in an unwanted brittleness of the composite part, which can limit its applicability in certain applications due to performance concerns. Thus, it can be desirable to produce a composite with a combination of similar or even higher impact properties and a less brittle failure mode than that offered by conventional long fiber reinforcements in thermoplastic resin, polypropylene being the choice in the present case.

To that end, it is known that the use of certain relatively high flow elastomer(s) in fiber reinforced thermoplastic polymer compositions can increase impact properties of the long fiber reinforced product, even beyond the effect of long fibers already present in the composite. Incorporation of these high melt flow elastomers can also promote a more ductile failure mode and result in a product that has a softer touch or feel along with a relatively low surface gloss.

Further, the pultrusion process can be used to produce long glass filled or reinforced thermoplastic pellets. However, this process can be very sensitive to the polymer flow characteristics. Poor flow, or relatively high viscosity of the polymer can limit the degree of impregnation of the reinforcing continuous fibers by the polymer resulting in poor pellet quality of the product. This challenge can be a limiting factor in choice of additives or property enhancers—especially if they inherently have a low flow characteristic.

Accordingly, there remains a need for fiber reinforced thermoplastic compositions that can provide improved impact strength properties and other improved mechanical properties and which can be manufactured through a variety of methods, including pultrusion, without restriction due to poor flow characteristics. More specifically, there remains a need for fiber reinforced thermoplastic compositions comprising relatively low melt flow elastomers that exhibit desired levels of impact properties and ductile failure mode.

These needs and other needs are satisfied by the compositions and methods of the present disclosure.

### SUMMARY

In accordance with the purpose(s) of the invention, as embodied and broadly described herein, this disclosure, in one aspect, relates to fiber reinforced thermoplastic polymer compositions having rigidity and improved impact resistance. Accordingly, in a first aspect, the present invention provides, a fiber reinforced thermoplastic composition, comprising a polypropylene polymer component; a low melt flow elastomer component having a melt flow index (MFI) less than about 30 g/10 minutes as measured at a temperature of 190° C. and under 2.16 kg of load; and a fiber reinforcement component.

In another aspect the present invention provides, a fiber reinforced thermoplastic composition, comprising: from 10 to 90 weight percent of a polypropylene polymer component; from 1 to 30 weight percent of an ethylene-butene elastomer component having a melt flow index (MFI) in the range of from 5 to 20 g/10 minutes as measured at a temperature of 190° C. and under 2.16 kg of load; and from 10 to 70 weight percent of a glass fiber reinforcement component. According to this aspect, the fiber reinforced thermoplastic composition exhibits improved impact properties relative to a reference composition in the absence of the ethylene-butene elastomer component.

In still another aspect, the present invention provides a method for the manufacture of a fiber reinforced thermoplastic composition. The method generally comprising providing thermoplastic resin mixture comprising: i) a polypropylene polymer component; and ii) a low melt flow elastomer component having a melt flow index (MFI) less than about 30 g/10 minutes as measured at a temperature of 190° C. and under 2.16 kg of load; providing a glass fiber reinforcement component; and contacting the glass fiber reinforcement component with the thermoplastic resin mixture to provide a fiber reinforced thermoplastic composite.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several aspects and together with the description serve to explain the principles of the invention.

FIG. 1A is a picture of a control test specimen according to Example 4 herein and illustrates a more brittle failure mode associated with a reference or control composite with 40 wt % long glass fiber (LGF) in the absence of an elastomer.

FIG. 1B is a picture of an inventive test specimen according to Example 4 herein and illustrates a more ductile failure mode associated with composition comprising 40 wt % LGF in the presence of an elastomer.

### DETAILED DESCRIPTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific aspects of compositions, articles, devices, systems, and/or methods disclosed unless otherwise specified, as such can, of course, vary. It is also to be understood that the terminology used herein is for the purpose of describing particular aspects of the invention only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Any publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” may include the aspects or aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a glass fiber” includes mixtures of two or more such glass fibers.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit falling within a range between two particular units are also disclosed. For example, if 10 and 15 are disclosed, then 11, 12, 13, and 14 are also disclosed.

As used herein, the terms “optional” or “optionally” mean that the subsequently described event, condition, component, or circumstance may or may not occur, and that the description includes instances where said event or circumstance occurs and instances where it does not.

As used herein, the term or phrase “effective,” “effective amount,” or “conditions effective to” refers to such amount or condition that is capable of performing the function or property for which an effective amount is expressed. As will be pointed out below, the exact amount or particular condition required may vary from one aspect or aspect to another, depending on recognized variables such as the materials employed and the processing conditions observed. Thus, it is not always possible to specify an exact “effective amount” or “condition effective to” for each aspect or aspect encompassed by the present disclosure. However, it should be understood that an appropriate effective amount or condition effective to achieve a desired results will be readily determined by one of ordinary skill in the art using only routine experimentation.

Disclosed are the components to be used to prepare disclosed compositions of the invention as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation can not be explicitly disclosed, each is specifically contemplated and described herein. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular component in a composition or article, denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

Each of the component starting materials disclosed herein are either commercially available and/or the methods for the production thereof are known to those of skill in the art.

As briefly summarized above, aspects of the present disclosure provide fiber reinforced thermoplastic polymer compositions that exhibit one or more improved performance properties relative to conventional reinforced thermoplastic compositions. For example, the disclosed fiber reinforced thermoplastic polymer compositions can exhibit one or more of improved impact properties, improved ductile failure mode, and can exhibit a softer touch or feel along with a relatively low surface gloss. To that end, as one of ordinary skill in the art will appreciate, conventional reinforced thermoplastic materials typically contain a thermoplastic material that has been blended with glass reinforcing fibers to impart rigidity and improve impact strength as evidenced, for example, by a general increase in tensile strength and modulus. However, the addition of reinforcing glass fibers also typically reduces the elastic properties of the thermoplastic material as evidence, for example, by a reduced ductility or tensile elongation or strain.

The disclosed fiber reinforced compositions of the present invention generally comprise a thermoplastic polymer component and a fiber reinforcement component. However, in contrast to conventional fiber reinforced materials, the compositions of the present invention further comprise a low melt flow elastomer component. Surprisingly and unexpectedly, the incorporation of a low melt flow elastomeric component in the disclosed reinforced thermoplastic compositions results in a reinforced composition that exhibits one or more improved performance properties relative to conventional reinforced thermoplastic compositions in the absence of the low melt flow elastomeric component. For example, the disclosed fiber reinforced thermoplastic polymer compositions exhibit one or more of an improved impact property, more ductile and less brittle failure mode, and can exhibit a softer touch or feel along with a relatively low surface gloss.

As noted above, the disclosed compositions comprise a thermoplastic polymer component. The thermoplastic polymer component comprises at least one thermoplastic polymer. In one aspect, the thermoplastic polymer component can comprise a single thermoplastic polymeric material or, alternatively, in another aspect can comprise a blend of two or more different thermoplastic polymer materials. The thermoplastic polymer component can comprise any thermoplastic polymer or mixture of polymers suitable for use in the composition or in an intended application. According to some aspects, the thermoplastic polymer component comprises a polypropylene polymer component. For example, in some aspects the polypropylene component can comprise a polypropylene homopolymer. According to an exemplary non-limiting aspect, a commercially available polypropylene homopolymer suitable for use in the compositions and methods disclosed and described herein is the Innovene H20H grade polypropylene available from Ineos Technologies. The Innovene H20H grade polypropylene has a melt flow index (MFI) of about 20 g/10 minutes when measured at a temperature of 230° C. and under 2.16 kg load. In a still further exemplary and non-limiting aspect, another commercially available polypropylene homopolymer suitable for use in the compositions and methods disclosed and described herein is the Bapolene® 4042 polypropylene resin available from Bamburger Polymers, Inc. the Bapolene® 4042 has a MFI of about 4 g/10 minutes when measured at a temperature of 230° C. and under 2.16 kg load.

Alternatively, the polypropylene component can comprise a polypropylene co-polymer. The thermoplastic polymer component can be present in the composition in any desired amount. However, in some aspects the thermoplastic polymer component be present in the composition in an amount in the range of from about 10 weight percent to 90 weight percent of the composition, including such exemplary amounts as 15, 20, 25, 30, 35, 40, 45, 50, 55, 60, 65, 70, 75, 80, or 85 weight percent. In still further aspects, the thermoplastic polymer component can be present in an amount within any range derived from any two of the above values, including for example, an amount in the range of from 10 weight percent to 70 weight percent, or an amount in the range of from 20 weight percent to 70 weight percent.

As also noted above, the disclosed compositions further comprise a low melt flow elastomer component. The low melt flow elastomer component can be characterized by having a melt flow index (MFI) value less than 30 g/10 minutes when measured at a temperature of 190° C. and under 2.16 kg of load. In further aspects, the low melt flow elastomer component can exhibit a melt flow index value less than 25 g/10 minutes, less than 20 g/10 minutes, less than 15 g/10 minutes, less than 10 g/10 minutes, or even less than 5 g/10 minutes when measured at a temperature of 190° C. and under 2.16 kg of load. In still further aspects, the low melt flow elastomer component exhibits a melt flow index in any range derived from any two of the above disclosed melt flow index values, including for example, a melt flow index in the range of from 5 to 20 g/10 minutes when measured at a temperature of 190° C. and under 2.16 kg of load. As used herein, melt flow index values can, for example and without limitation, be determined according to the ASTM D1238 testing protocol.

Exemplary low melt flow elastomers suitable for use in the disclosed compositions include the class of ethylene containing elastomers, including for example ethylene-butene copolymer elastomers and ethylene-octene copolymer elastomers. Similar to the thermoplastic polymer component, the low melt flow elastomer component can comprise a single low melt flow elastomer or, alternatively, can comprise a blend of two or more different low melt flow elastomers. Further, although the low melt flow elastomer component can be present in the composition in any desired amount, it can be preferable according to some aspects for the low melt flow elastomer component to be present in the composition in an amount in the range of from greater than 0 weight percent to 30 weight percent, including exemplary amounts of 1 weight percent, 5 weight percent, 10 weight percent, 15 weight percent, 20 weight percent, and 25 weight percent. In still further aspects, the low melt flow elastomer component can be present in the composition in an amount in any range derived from any two of the above disclosed weight percent values, including for example from 5 to 20 weight percent or from 10 to 20 weight percent. An exemplary non-limiting example of a commercially available ethylene-butene elastomer suitable for use in the compositions and methods disclosed herein is the Engage 7447 available from Dow Chemicals. Exemplary non-limiting examples of commercially available ethylene-octene elastomers suitable for use in the compositions and methods disclosed herein include Engage 8200, Engage 8137 and Engage 8407, all of which are also available from Dow Chemicals.

The disclosed compositions further comprise a fiber reinforcement component. Preferrably, the fiber reinforcement component comprises a plurality of glass fibers. To that end, the glass fibers can be relatively short glass fibers, relatively long glass fibers, or a combination of both short and long glass fibers. As used herein, the term short glass fibers refers to a population of glass fibers having an average fiber length less than or equal to about 5 mm. As used herein, the term long glass fibers refers to a population of glass fibers having an average fiber length greater than about 5 mm, including for example, a population of glass fibers having a fiber length in the range of from greater than 5 mm to 15 mm. The fiber reinforcement component can be present in the composition in any desired amount. However, in some aspects, the reinforcement component can be present in the composition in an amount from greater than 0 weight percent to about 70 weight percent, including exemplary amounts of 5 weight percent, 10 weight percent, 15 weight percent, 20 weight percent, 25 weight percent, 30 weight percent, 35 weight percent, 40 weight percent, 45 weight percent, 50 weight percent, 55 weight percent, 60 weight percent, and 65 weight percent. In still further aspects, the fiber reinforcement component can be present in the composition in an amount in any range derived from any two of the above disclosed weight percent values, including for example from 20 to 50 weight percent or from 30 to 50 weight percent. Exemplary long glass fibers suitable for use in a pultrusion process as described herein include, without limitation, TufRov® 4588 glass fibers commercially available from PPG Industries. Exemplary short or chopped glass fibers suitable for use in disclosed samples, including those prepared by twin screw extrusion compounding as exemplified herein, include without limitation the ThermoFlow® 738 glass fibers commercially available from Johns Manville.

The disclosed compositions can further comprise one or more optional additive components, including for example, one or more additive selected from the group consisting of a coupling agent, antioxidant, heat stabilizer, flow modifier, and colorant. For example, and without limitation, an exemplary coupling agent suitable for use as an additive component in the disclosed compositions includes the Polybond® 3150 maleic anhydride grafted polypropylene commercially available from Chemtura or the Fusabond P613 maleic anhydride grafted polypropylene commercially available from DuPont. An exemplary flow modifier suitable for use as an additive component in the disclosed compositions can include, without limitation, the CR20P peroxide masterbatch commercially available from Polyvel Inc. Still further, an exemplary stabilizer suitable for use as an additive component in the disclosed compositions can include, without limitation, the Irganox® B225 commercially available from BASF. In a still further aspect, neat polypropylene can be introduced as an optional additive. For example, neat polypropylene can be introduced in a dry blending step during a molding process to alter levels of glass fiber loading in a composition.

According to aspects of the invention, the disclosed fiber reinforced thermoplastic polymer compositions can exhibit one or more improved performance properties when compared to a conventional or reference composition in the absence of the low melt flow elastomer component. For example, the disclosed compositions can exhibit one or more of improved impact properties, more ductile and less brittle failure modes, a softer touch or feel, and a relatively low surface gloss. Further, it should be understood that these improved properties relative to the comparative reference compositions can be provided in any combination or they can occur individually for a given composition.

For purposes of the described comparisons to a corresponding conventional or reference composition it should be understood that a corresponding reference composition consists essentially of the same component materials in the same component amounts as the inventive composition but for the absence of the low melt flow elastomer component. Further, in the corresponding reference composition the weight percentage amount of the thermoplastic polymer component has been increased to compensate for the absence of the low melt flow elastomer component such that the weight percent of the fiber reinforcement component and any optional additive components are the same in both the inventive composition and the corresponding reference composition. For example, and without limitation, an exemplary inventive fiber reinforced composition and a corresponding reference composition in the absence of a low melt flow elastomer are set forth in Table 1 below.

TABLE 1

| Component | Reference (wt. %) | Inventive (wt. %) |
|---|---|---|
| Long Glass Fiber | 30 | 30 |
| Polypropylene | 67.28 | 47.28 |
| Coupling agent | 1.93 | 1.93 |
| Stabilizer | 0.60 | 0.60 |
| Flow modifier | 0.20 | 0.20 |
| Low Melt Flow Elastomer | 0.00 | 20.0 |
| Total | 100.1 | 100.1 |

As illustrated in the table, the exemplified inventive composition and the reference composition each comprise the same component materials in the same component amounts, except for the low melt flow elastomer component and the polypropylene component. To that end, the reference composition comprises 67.28 weight percent of the polypropylene component and none of the low melt flow elastomer. In contrast, the inventive composition comprises 20.0 weight percent of the low melt flow elastomer and an amount of polypropylene (i.e., 47.28 weight percent) that has been reduced by 20 weight percent to compensate for the addition of the low melt flow elastomer.

According to further aspects of the invention, the disclosed compositions can also exhibit improved impact properties relative to a corresponding reference composition in the absence of the low melt flow elastomer component. These improved impact properties can be characterized by an increase in notched izod impact strength, an increase in unnotched izod impact strength, and an increase in multi axial impact strength. For example, according to aspects of the invention, disclosed compositions can exhibit at least about a 5% greater notched izod impact strength than that of a corresponding reference composition. Further aspects can exhibit even greater increases in notched izod impact strength, including for example increases of at least about 10% greater, at least about 15% greater, at least about 20%, at least about 25% greater, and even at least about 30% greater. Still further, these increases in notched izod impact strength can be obtained at ambient temperature conditions as measured at about 23° C., or at sub zero temperature conditions as measured at about −40° C., or even under both ambient and subzero temperature conditions. In still further aspects, these increases in notched izod impact strength can be obtained within a range of temperatures, including for example, a range of temperatures of from 23° C. to −40° C. As referred to herein, the notched izod impact strength values can be obtained according to the ISO 180 testing procedures.

According to aspects of the invention, the disclosed compositions can also exhibit improved unnotched izod impact strength. For example, disclosed compositions can exhibit at least about a 5% greater unnotched izod impact strength than that of a corresponding reference composition. Further aspects can exhibit even greater increases in unnotched izod impact strength, including for example increases of at least about 10% greater, at least about 15% greater, at least about 20%, at least about 25% greater, and even at least about 30% greater. Still further, these increases in unnotched izod impact strength can be obtained at ambient temperature conditions as measured at about 23° C., or at sub zero temperature conditions as measured at about −40° C., or even under both ambient and subzero temperature conditions. In still further aspects, these increases in unnotched izod impact strength can be obtained within a range of temperatures, including for example, a range of temperatures of from 23° C. to −40° C. As referred to herein, the unnotched izod impact strength values can be obtained according to the ISO 180 testing procedures.

In addition to the increased notched and unnotched impact strengths, according to further aspects of the invention disclosed compositions can exhibit improved impact properties characterized by an increase in multi axial impact strength. For example, according to some aspects of the invention, disclosed compositions can exhibit at least about a 5% greater multi axial impact strength than that of a corresponding reference composition. Further aspects can exhibit even greater increases in multi axial impact strength, including for example increases of at least about 10% greater, at least about 15% greater, at least about 20%, at least about 25% greater, and even at least about 30% greater. Still further, these increases in multi axial impact strength can be obtained at ambient temperature conditions as measured at about 23° C., or at sub zero temperature conditions as measured at about −40° C., or even under both ambient and subzero temperature conditions. In still further aspects, these increases in multi axial impact strength can be obtained within a range of temperatures, including for example, a range of temperatures of from 23° C. to −40° C. As referred to herein, the multi axial impact strength values can be obtained according to the ASTM D3763 testing procedures.

In still further aspects, fiber reinforced compositions of the present invention can exhibit a relatively softer touch or feel as compared to that of a reference composition. This softer touch or feel can be characterized by lower values of Shore D hardness as measured according to the ASTM D2240 testing procedures. For example, according to some aspects of the invention, disclosed compositions can exhibit Shore D hardness values that are at least about a 2% lower than that of a corresponding reference composition. Further aspects can exhibit even greater decreases in Shore D hardness values, including for example decreases of at least about 5%, at least about 8%, at least about 10%, at least about 12%, and even at least about 15% less than that of a corresponding reference composition.

The disclosed compositions can also exhibit relatively more ductile and less brittle failure mode compared to the failure mode of a corresponding reference composition. This improved ductility can, for example, be characterized by an increased tensile strain percentage as measured according to ISO 527 testing standards. For example, according to aspects of the invention, disclosed fiber reinforced compositions can exhibit a tensile strain percentage that is at least about 5% greater than that of a corresponding reference composition. Further aspects can exhibit even greater increases in tensile strain percentage, including for example increases of at least about 10% greater, at least about 15% greater, at least about 20%, at least about 25% greater, and even at least about 30% greater.

In still further aspects, the present disclosure provides methods for the manufacture of the fiber reinforced thermoplastic compositions described herein. According to the disclosed methods, a thermoplastic resin mixture comprising a thermoplastic polymeric component as described above and a low melt flow elastomer component as described above is provided. For example, and without limitation, a thermoplastic resin mixture can be provided that comprises a polypropylene polymer component and a low melt flow elastomer component having a melt flow index (MFI) less than about 30 g/10 minutes as measured at a temperature of 190° C. and under 2.16 kg of pressure.

A provided reinforcing fiber component as described above can then be contacted with the thermoplastic resin mixture to provide a fiber reinforced thermoplastic composite. As one of ordinary skill in the art will appreciate, this contacting step can vary depending upon the nature of the reinforcing fiber component. For example, according to some aspects the contacting step can be performed by a continuous one step pultrusion process. As one of ordinary skill in the art will appreciate, a pultrusion process is better suited for use in those aspects where the reinforcing fiber material comprises long glass fiber. According to these aspects, glass fiber rovings can be continuously pulled off a spool and through a thermoplastic resin mixture coating or impregnation station where they are coated or impregnated with a melt comprising the thermoplastic resin mixture. The coated or impregnated glass fiber strands can then be cooled and subsequently pelletized. These pellets can then be injection molded into test specimen parts in their existing form for property testing or into molded parts of varying complexity for use in desired end use applications. If one or more optional additives are desired to be incorporated into the fiber reinforced thermoplastic compositions, they can be introduced either during the pultrusion process or by dry-blending with pelletized reinforced thermoplastic composition following the pultrusion process and before any subsequent molding steps.

In alternative aspects where the fiber reinforcing material comprises short glass fibers, the step of contacting the short glass fibers with the thermoplastic resin mixture can, for example, be performed by compounding the short glass fibers together with the thermoplastic resin mixture. This compounding can be performed using any conventionally known equipment used for the manufacture of fiber reinforced thermoplastic composite materials, including for example the use of a twin screw extruder. The extruded glass fiber reinforced composition can then be cooled and subsequently pelletized. These pellets can then be injection molded into test specimen parts in their existing form for property testing or into molded parts of varying complexity for use in desired end use applications. Once again, if one or more optional additives are desired to be incorporated into the fiber reinforced thermoplastic composition, they can be introduced either during the extrusion process or by dry-blending with pelletized reinforced thermoplastic composition following the extrusion process and before any subsequent molding steps.

The optional additives disclosed herein can be introduced into the compositions either before or during a molding process. For example, one or more optional additives can be introduced into a thermoplastic resin mixture or composition before glass fiber reinforcement components are blended or otherwise introduced into the thermoplastic resin mixture. Alternatively, one or more optional additives can be introduced into a composition after the glass fiber reinforcement component has been blended or otherwise introduced into a composition. In still further aspects, one or more optional additives can be introduced during a dry blending step performed during a molding process.

The fiber reinforced thermoplastic compositions disclosed and described herein can be used in various end use applications, including in applications where relatively high impact properties are desired, where a relatively soft touch or feel is desire; and/or where a vibration dampening effect is desired. Examples of uses include thermoplastic articles conventionally utilized in connection with outdoor lawn and garden power equipment, power tools such as drills, grinders, etc. where high impact and/or soft touch feel for better grips my be desired. The disclosed compositions are also well suited for use in the manufacture of furniture related applications for industrial, office, medical, or household use. Still further, the disclosed compositions can be used in food and fluid storage and handling applications where high impact properties are desired. In still further aspects, the disclosed compositions are suitable for use in connection with weaponry, including for example, gun stocks or blade handles and grips. In still further aspects, the disclosed compositions can be useful in connection with various automotive parts, transportation applications, sports and recreation equipment, including for example, applications where vibration dampening effects are desired.

While typical aspects have been set forth for the purpose of illustration, the foregoing descriptions should not be deemed to be a limitation on the scope of the invention. Accordingly, various modifications, adaptations, and alternatives can occur to one skilled in the art without departing from the spirit and scope of the present invention.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

In the following examples, the improved impact performance and failure mode of various long and short fiber reinforced polypropylene homopolymer resins comprising a low melt flow elastomers were evaluated. Long glass fiber polypropylene pellets were produced by a pultrusion method using a Berstorff 44 mm twin-screw extruder operated at a barrel temperature of about 260-305° C. (500-580° F.) and screw speed of 300 rpm. Controlling long glass content is well known to one of ordinary skill in the art and can be done precisely by using outlet dies with known opening diameters through which the polymer-impregnated glass is pultruded. The pultruded samples were then molded into ISO/ASTM test specimens for property testing. All samples were generated at line speeds of 20-25 ft/min. The short glass filled polypropylene samples were made on a 40 mm twin-screw extruder operated at a barrel temperature of about 200-220° C. (390-430° F.), a screw speed of 200 rpm, and a throughput of 45 lbs/hr.

### Example 1

In this first example, sample property results for both 30 weight % and 50 weight % long glass fiber reinforced polypropylene samples comprising 20 weight percent of an ethylene-butene low melt flow elastomer (5 g/10 min) were evaluated and compared to control samples that did not contain the low melt flow elastomer component. The specific formulations are set forth in Table 1a below.

TABLE 1A

| | | Ethylene- | | Ethylene- |
|---|---|---|---|---|
| | No | butene | No | butene |
| | elastomer | 5 g/10 min | elastomer | 5 g/10 min |
| Component | Sample | Sample | Sample | Sample |
| (weight %) | 17256-1 | 17256-3 | 17257-1 | 17257-3 |
| Long glass fiber | 30 | 30 | 50 | 50 |
| (PPG 4588) | | | | |
| PP homopolymer | 67.28 | 47.28 | 46.20 | 26.20 |
| (Innovene H20H) | | | | |
| Coupling agent | 1.93 | 1.93 | 3.00 | 3.00 |
| (Polybond 3150) | | | | |
| Stabilizer | 0.60 | 0.60 | 0.60 | 0.60 |
| (Irganox B225) | | | | |
| Flow modifier | 0.20 | 0.20 | 0.20 | 0.20 |
| (peroxide) | | | | |
| (Polyvel CR20P) | | | | |
| Ethylene-butene | 0.00 | 20.01 | 0.00 | 20.00 |
| elastomer | | | | |
| (Engage 7447) | | | | |
| Sum | 100.00 | 100.00 | 100.00 | 100.00 |

Various properties of test specimens formed from the compositions of Table 1a were then measured, the results of which are set forth in Table 1b. It can be seen that the presence of the ethylene-butene elastomer in both the 30% and 50% long fiber reinforced polypropylene composition improved impact properties as reflected by the Multi Axial Impact, and Notched and Unnotched Izod Impact strength measurements. Improved ductility in presence of the elastomer can also been seen from higher tensile strain values. Further, the reduction in the Shore D hardness values illustrates that a softer touch to the composite surface was obtained.

TABLE 1B

| | | | | Ethylene- | | Trial |
|---|---|---|---|---|---|---|
| | | | No | butene | No | 20% Engage |
| | Test | | elastomer | 5 g/10 min | elastomer | 7447 |
| Property | Standard | Units | 30% long glass fiber | | 50% long glass fiber | |
| Density | ASTM | g/cm³ | 1.117 | 1.110 | 1.308 | 1.308 |
| | D792 | | | | | |
| Tensile | ISO 527 | MPa | 123 | 104 | 140 | 93 |
| Strength | | | | | | |
| Tensile | ISO 527 | MPa | 6151 | 5279 | 9808 | 7067 |
| Modulus | | | | | | |
| Tensile Strain | ISO 527 | % | 2.61 | 2.94 | 1.98 | 2.58 |
| Flex Strength | ISO 178 | MPa | 151 | 126 | 197 | 120 |
| Flex Modulus | ISO 178 | MPa | 5638 | 4809 | 10062 | 7263 |
| NII (23° C.) | ISO 180 | kJ/m² | 25 | 26 | 33 | 44 |
| NH (−40° C.) | ISO 180 | kJ/m² | 27 | 26 | 39 | 47 |
| UNII | ISO 180 | kJ/m² | 53 | 57 | 66 | 79 |
| (23° C.) | | | | | | |
| UNII | ISO 180 | kJ/m² | 43 | 59 | 66 | 78 |
| (−40° C.) | | | | | | |
| MAI | ASTM | J | 12.7 | 17.1 | 12.4 | 17.1 |
| (23° C.) | D3763 | | | | | |
| MAI | ASTM | J | 13.7 | 15.9 | 14.9 | 18.9 |
| (−40° C.) | D3763 | | | | | |
| HDT | ISO 75 | ° C. | 158 | 150 | 156 | 149 |
| Hardness | ASTM | Shore D | 74 | 67.8 | 75.2 | 66.2 |
| | D2240 | | | | | |

### Example 2

In this second example, sample property results for both 30 weight % and 50 weight % short (chopped) glass fiber reinforced polypropylene samples comprising 20 weight percent of an ethylene-butene low melt flow elastomer (5 g/10 min) were evaluated and compared to control samples that did not contain the low melt flow elastomer component. The specific formulations are set forth in Table 2a below.

TABLE 2A

| | | Ethylene- | | Ethylene- |
|---|---|---|---|---|
| | No | butene | No | butene |
| | elastomer | 5 g/10 min | elastomer | 5 g/10 min |
| Component | Sample | Sample | Sample | Sample |
| (weight %) | 17260-1 | 17260-3 | 17260-5 | 17260-6 |
| Short glass fiber | 30 | 30 | 50 | 50 |
| (Johns Manville 738) | | | | |
| PP homopolymer | 67.00 | 47.00 | 47.00 | 27.00 |
| (Bamberger 4042) | | | | |
| Coupling agent | 3.00 | 3.00 | 3.00 | 3.00 |
| (Fusabond P613) | | | | |
| Ethylene-butene | 0.00 | 20.00 | 0.00 | 20.00 |
| elastomer | | | | |
| (Engage 7447) | | | | |
| Sum | 100.00 | 100.00 | 100.00 | 100.00 |

Again, various impact properties of test specimens formed from the compositions of Table 2a were then measured, the results of which are set forth in Table 2b. It can again be seen that the presence of the ethylene-butene elastomer in both the 30% and 50% short or chopped fiber reinforced polypropylene composition improved impact properties as reflected by the, Multi Axial Impact, and Notched and Unnotched Izod Impact strength measurements. Higher tensile strain values in presence of the ethylene-butene elastomer indicate improved ductility over the reference compositions without the elastomer. Further, the reduction in the Shore D hardness values illustrates that a softer touch to the composite surface was obtained.

TABLE 2B

| | | | No | Ethylene-butene | No | Trial 20% |
|---|---|---|---|---|---|---|
| | Test | | elastomer | 5 g/10 min | elastomer | Engage 7447 |
| Property | Standard | Units | 30% long glass fiber | | 50% long glass fiber | |
| Density | ASTM D792 | g/cm³ | 1.120 | 1.107 | 1.333 | 1.323 |
| Tensile Strength | ISO 527 | MPa | 86 | 54 | 104 | 45 |
| Tensile Modulus | ISO 527 | MPa | 5822 | 4213 | 8983 | 4867 |
| Tensile Strain | ISO 527 | % | 3.08 | 5.01 | 2.65 | 3.71 |
| Flex Strength | ISO 178 | MPa | 129 | 77 | 166 | 68 |
| Flex Modulus | ISO 178 | MPa | 5755 | 4064 | 10230 | 5589 |
| NII (23° C.) | ISO 180 | kJ/m² | 12 | 28 | 14 | 31 |
| NII (−40° C.) | ISO 180 | kJ/m² | 9 | 12 | 11 | 15 |
| UNII (23° C.) | ISO 180 | kJ/m² | 47 | 73 | 50 | 76 |
| UNII (−40° C.) | ISO 180 | kJ/m² | 47 | 57 | 53 | 58 |
| MAI (23° C.) | ASTM D3763 | J | 11.5 | 14.7 | 12.4 | 13.7 |
| MAI (−40° C.) | ASTM D3763 | J | 7.16 | 9.06 | 8.62 | 15 |
| HDT | ISO 75 | ° C. | 142 | 120 | 149 | 120 |
| Hardness | ASTM D2240 | Shore D | 75.6 | 67.8 | 67.2 | 65 |

### Example 3

In this example, the effect of various elastomers, each at a 5 weight % loading, were evaluated in 40 weight % long glass fiber reinforced polypropylene samples. Specifically, compositions comprising four different elastomers were compared to a reference or control sample in the absence of the low melt flow elastomer. The four elastomers evaluated were: 1) ethylene-butene elastomer having a MFI of 5 g/10 min; 2) etheylene-octene elastomer having a MFI of 5 g/10 min; 3) ethylene-octene elastomer having a MFI of 13 g/10 min; and 4) ethylene-octene elastomer having a MFI of 30 g/10 min. The specific formulation for each composition tested in this example was as set forth in Table 3a below:

TABLE 3A

| | | 5 wt % |
|---|---|---|
| | No | respective |
| Component (weight %) | elastomer | elastomer |
| Long glass fiber (PPG 4588) | 40 | 40 |
| PP homopolymer (Innovene H20H) | 56.80 | 51.80 |
| Coupling agent (Polybond 3150) | 2.40 | 2.40 |
| Stabilizer (Irganox B225) | 0.60 | 0.60 |
| Flow modifier (peroxide) (Polyvel CR20P) | 0.20 | 0.20 |
| Ethylene-butene or ethylene-octene elastomer | 0.00 | 5.00 |
| Sum | 100.00 | 100.00 |

Table 3b shows the property comparison for the various elastomers including ethylene-butene and ethylene-octene at 5 wt % content level evaluated in 40% long glass fiber reinforced polypropylene. It can again be seen that the presence of the elastomers improved impact properties as reflected by the, Multi Axial Impact, and Notched and Unnotched Izod Impact strength measurements.

TABLE 3B

| | | | | Ethylene- | Ethylene- | Ethylene- | Ethylene- |
|---|---|---|---|---|---|---|---|
| | | | | butene | octene | octene | octene |
| | | | No | MFI | MFI | MFI | MFI |
| | | | Elastomer | 5 g/10 min | 5 g/10 min | 13 g/10 min | 30 g/10 min |
| Property | Standard | Units | 40% long glass fiber | | | | |
| Density | ASTM | g/cm³ | 1.198 | 1.184 | 1.186 | 1.192 | 1.187 |
| | D792 | | | | | | |
| Tensile | ISO 527 | MPa | 7482 | 7343 | 7186 | 7056 | 7005 |
| Modulus | | | | | | | |
| Tensile | ISO 527 | MPa | 139 | 136 | 131 | 125 | 125 |
| Strength | | | | | | | |
| Tensile | ISO 527 | % | 2.55 | 2.76 | 2.67 | 2.62 | 2.64 |
| Strain | | | | | | | |
| Izod Impact, | ISO 180 | kJ/m² | 57 | 65 | 67 | 66 | 61 |
| unnotched | | | | | | | |
| (23° C.) | | | | | | | |
| Izod Impact, | ISO 180 | kJ/m² | 39 | 63 | 54 | 53 | 45 |
| unnotched (−40° C.) | | | | | | | |
| Izod Impact, | ISO 180 | kJ/m² | 25 | 41 | 32 | 30 | 28 |
| notched | | | | | | | |
| (23° C.) | | | | | | | |
| MAI | ASTM | J | 15 | 16 | 17 | 15 | 16 |
| (23° C.) | D3763 | | | | | | |
| MAI | ASTM | J | 14 | 17 | 15 | 17 | 17 |
| (−40° C.) | D3763 | | | | | | |

### Example 4

In this example, the effect of various elastomers, each at a 20 weight % loading, were evaluated in a 40 weight % long glass fiber reinforced polypropylene samples. Compositions comprising four different elastomers were again compared to a reference or control sample in the absence of the low melt flow elastomer. The four elastomers evaluated were: 1) ethylene-butene elastomer having a MFI of 5 g/10 min; 2) ethylene-octene elastomer having a MFI of 5 g/10 min; 3) ethylene-octene elastomer having a MFI of 13 g/10 min; and 4) ethylene-octene elastomer having a MFI of 30 g/10 min. The specific formulation for each composition tested in this example was as set forth in Table 4a below:

TABLE 4A

| | | 20 wt % |
|---|---|---|
| | No | respective |
| Component (weight %) | elastomer | elastomer |
| Long glass fiber (PPG 4588) | 40 | 40 |
| PP homopolymer (Innovene H20H) | 56.8 | 36.8 |
| Coupling agent (Polybond 3150) | 2.4 | 2.4 |
| Stabilizer (Irganox B225) | 0.60 | 0.60 |
| Flow modifier (peroxide) (Polyvel CR20P) | 0.20 | 0.20 |
| Ethylene-butene or ethylene-octene elastomer | 0.00 | 20.00 |
| 100.00 | 100.00 | 100.00 |

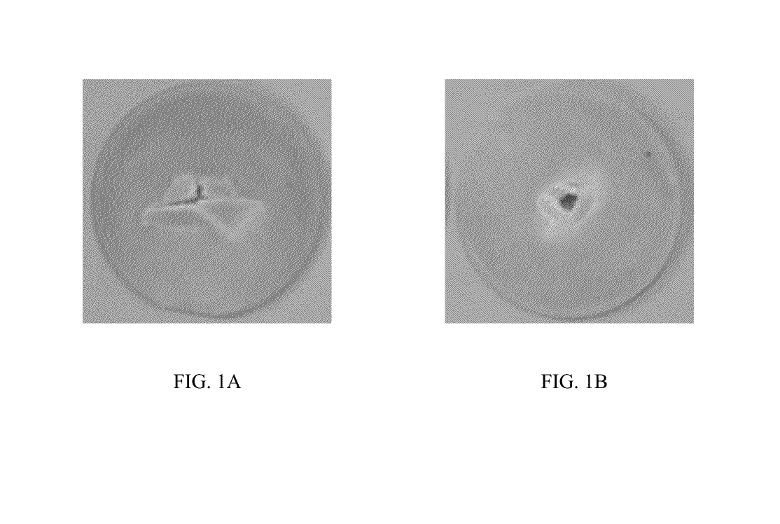

Table 4b shows the property comparison for the various elastomers including ethylene-butene and ethylene-octene at 20 wt % content level evaluated in 40% long glass fiber reinforced polypropylene. It can again be seen that the presence of the elastomers improved impact properties as reflected by the, Multi Axial Impact, and Notched and Unnotched Izod Impact strength measurements. Again, improved ductility of the product in presence of the elastomer(s) can be noted through the increase in tensile strain values. Additionally, the change in failure mode from a brittle to a more ductile nature for the composite with 40 wt % LGF in presence of the elastomer (FIG. 1B) relative to the reference or control (FIG. 1A) is shown in FIGS. 1A and 1B.

TABLE 4B

| | | | | Ethylene- | Ethylene- | Ethylene- | Ethylene- |
|---|---|---|---|---|---|---|---|
| | | | | butene | octene | octene | octene |
| | | | No | MFI | MFI | MFI | MFI |
| | | | Elastomer | 5 g/10 min | 5 g/10 min | 13 g/10 min | 30 g/10 min |
| Property | Standard | Units | 40% long glass fiber | | | | |
| Density | ASTM | g/cm³ | 1.1975 | 1.2147 | 1.2447 | 1.1949 | 1.2344 |
| | D792 | | | | | | |
| Tensile | ISO 527 | MPa | 7482 | 8194 | 6516 | 6719 | 6930 |
| Modulus | | | | | | | |
| Tensile | ISO 527 | MPa | 139 | 127 | 100 | 116 | 104 |
| Strength | | | | | | | |
| Izod Impact, | ISO 180 | kJ/m² | 57 | 71 | 59 | 60 | 63 |
| unnotched | | | | | | | |
| (23° C.) | | | | | | | |
| Izod Impact, | ISO 180 | kJ/m² | 39.4 | 75 | 63 | 68 | 69 |
| unnotched (−40° C.) | | | | | | | |
| Izod Impact, | ISO 180 | kJ/m² | 25 | 40 | 26 | 28 | 26 |
| notched | | | | | | | |
| (23° C.) | | | | | | | |
| Izod Impact, | ISO 180 | kJ/m² | 24 | 46 | 24 | 29 | 24 |
| Notched (−40° C.) | | | | | | | |
| MAI | ASTM | J | 15 | 22 | 14 | 14 | 14 |
| (23° C.) | D3763 | | | | | | |
| MAI | ASTM | J | 14.4 | 16 | 12 | 13 | 16 |
| (−40° C.) | D3763 | | | | | | |

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fiber reinforced thermoplastic composition, comprising:
a) a polypropylene polymer component;
b) a low melt flow elastomer component having a melt flow index (MFI) less than about 30 g/10 minutes as measured at a temperature of 190° C. and under 2.16 kg of load; and
c) a fiber reinforcement component.

2. The fiber reinforced thermoplastic composition of claim 1, comprising:
a) from 10 to 90 weight percent of the polypropylene polymer component;
b) from 1 to 30 weight percent of the low melt flow elastomer component; and
c) from 10 to 70 weight percent of the fiber reinforcement component.

3. The fiber reinforced thermoplastic composition of claim 1, wherein the polypropylene polymer component comprises a polypropylene homo-polymer.

4. The fiber reinforced thermoplastic composition of claim 1, wherein the polypropylene polymer component comprises a polypropylene co-polymer.

5. The fiber reinforced thermoplastic composition of claim 1, wherein the low melt flow elastomer component comprises an ethylene containing elastomer.

6. The fiber reinforced thermoplastic composition of claim 1, wherein the low melt flow elastomer component comprises an ethylene-butene elastomer.

7. The fiber reinforced thermoplastic composition of claim 1, wherein the low melt flow elastomer component comprises an ethylene-octene elastomer.

8. The fiber reinforced thermoplastic composition of claim 1, wherein the low melt flow elastomer component has a melt flow index (MFI) less than about 20 g/10 minutes as measured at a temperature of 190° C. and under 2.16 kg of load.

9. The fiber reinforced thermoplastic composition of claim 1, wherein the low melt flow elastomer component has a melt flow index (MFI) less than about 10 g/10 minutes as measured at a temperature of 190° C. and under 2.16 kg of load.

10. The fiber reinforced thermoplastic composition of claim 1, wherein the low melt flow elastomer component has a melt flow index (MFI) in the range of from about 5 to about 20 g/10 minutes as measured at a temperature of 190° C. and under 2.16 kg of load.

11. The fiber reinforced thermoplastic composition of claim 1, wherein the fiber reinforcement component comprises a glass fiber.

12. The fiber reinforced thermoplastic composition of claim 11, wherein the fiber reinforcement component comprises a long glass fiber.

13. The fiber reinforced thermoplastic composition of claim 11, wherein the fiber reinforcement component comprises short glass fibers.

14. The fiber reinforced thermoplastic composition of claim 1, further comprising one or more additive selected from the group consisting of a coupling agent, heat stabilizer, flow modifier, stabilizer(s) for improved weathering, and colorant.

15. The fiber reinforced thermoplastic composition of claim 1, wherein the composition exhibits at least about a 5% greater notched izod impact strength than that of a reference composition in the absence of the low melt flow elastomer.

16. The fiber reinforced thermoplastic composition of claim 1, wherein the composition exhibits at least about a 10% greater notched izod impact strength than that of a reference composition in the absence of the low melt flow elastomer.

17. The fiber reinforced thermoplastic composition of claim 1, wherein the composition exhibits at least about a 25% greater notched izod impact strength than that of a reference composition in the absence of the low melt flow elastomer.

18. The fiber reinforced thermoplastic composition of claim 1, wherein the composition exhibits at least about a 5% greater multi axial impact strength than that of a reference composition in the absence of the low melt flow elastomer.

19. The fiber reinforced thermoplastic composition of claim 1, wherein the composition exhibits at least about a 10% greater multi axial impact strength than that of a reference composition in the absence of the low melt flow elastomer.

20. The fiber reinforced thermoplastic composition of claim 1, wherein the composition exhibits at least about a 25% greater multi axial impact strength than that of a reference composition in the absence of the low melt flow elastomer.

21. The fiber reinforced thermoplastic composition of claim 1, wherein the composition exhibits at least about a 5% greater tensile strain than that of a reference composition in the absence of the low melt flow elastomer.

22. The fiber reinforced thermoplastic composition of claim 1, wherein the composition exhibits at least about a 10% greater tensile strain than that of a reference composition in the absence of the low melt flow elastomer.

23. The fiber reinforced thermoplastic composition of claim 1, wherein the composition exhibits at least about a 25% greater tensile strain than that of a reference composition in the absence of the low melt flow elastomer.

24. The fiber reinforced thermoplastic composition of claim 1, wherein the composition exhibits at more ductile and less brittle failure mode than a reference composition in the absence of the low melt flow elastomer.

25. The fiber reinforced thermoplastic composition of claim 1, wherein the composition exhibits a lesser Shore D hardness value than that of a reference composition in the absence of the low melt flow elastomer.

26. The fiber reinforced thermoplastic composition of claim 1, wherein the composition exhibits at least about a 5% greater unnotched izod impact strength than that of a reference composition in the absence of the low melt flow elastomer.

27. The fiber reinforced thermoplastic composition of claim 1, wherein the composition exhibits at least about a 10% greater unnotched izod impact strength than that of a reference composition in the absence of the low melt flow elastomer.

28. The fiber reinforced thermoplastic composition of claim 1, wherein the composition exhibits at least about a 25% greater unnotched izod impact strength than that of a reference composition in the absence of the low melt flow elastomer.

29. A fiber reinforced thermoplastic composition, comprising
a) from 40 to 60 weight percent of a polypropylene polymer component;
b) from 5 to 20 weight percent of an ethylene-butene elastomer component having a melt flow index (MFI) in the range of from 5 to 20 g/10 minutes as measured at a temperature of 190° C. and under 2.16 kg of pressure; and
c) from 30 to 50 weight percent of a glass fiber reinforcement component,
wherein the fiber reinforced thermoplastic composition exhibits at least about a 25% greater notched izod impact strength than that of a reference composition consisting essentially of substantially the same proportions of the fiber reinforcement component and the polypropylene polymer component in the absence of the ethylene-butene elastomer component.

30. A fiber reinforced thermoplastic composition, comprising:
a) from 10 to 90 weight percent of a polypropylene polymer component;
b) from 1 to 30 weight percent of an ethylene-butene elastomer component having a melt flow index (MFI) in the range of from 5 to 20 g/10 minutes as measured at a temperature of 190° C. and under 2.16 kg of load; and
c) from 10 to 70 weight percent of a glass fiber reinforcement component,
wherein the fiber reinforced thermoplastic composition exhibits at least about a 25% greater notched izod impact strength than that of a reference composition consisting essentially of substantially the same proportions of the fiber reinforcement component and the polypropylene polymer component in the absence of the ethylene-butene elastomer component.

31. A method for the manufacture of a fiber reinforced thermoplastic composition, comprising the steps of:
a) providing thermoplastic resin mixture comprising: i) a polypropylene polymer component; and ii) a low melt flow elastomer component having a melt flow index (MFI) less than about 30 g/10 minutes as measured at a temperature of 190° C. and under 2.16 kg of load;
b) providing a glass fiber reinforcement component; and
c) contacting the glass fiber reinforcement component with the thermoplastic resin mixture to provide a fiber reinforced thermoplastic composite.

32. The method of claim 31, wherein the polypropylene polymer component comprises a polypropylene homo-polymer.

33. The method of claim 31, wherein the polypropylene polymer component comprises a polypropylene co-polymer.

34. The method of claim 31, wherein the low melt flow elastomer component comprises an ethylene containing elastomer.

35. The method of claim 31, wherein the low melt flow elastomer component comprises an ethylene-butene elastomer.

36. The method of claim 31, wherein the low melt flow elastomer component comprises an ethylene-octene elastomer.

37. The method of claim 31, wherein the low melt flow elastomer component has a melt flow index (MFI) less than about 20 g/10 minutes as measured at a temperature of 190° C. and under 2.16 kg of load.

38. The method of claim 31, wherein the low melt flow elastomer component has a melt flow index (MFI) less than about 10 g/10 minutes as measured at a temperature of 190° C. and under 2.16 kg of load.

39. The method of claim 31, wherein the low melt flow elastomer component has a melt flow index (MFI) in the range of from about 5 to about 20 g/10 minutes as measured at a temperature of 190° C. and under 2.16 kg of load.

40. The method of claim 31, wherein the glass fiber reinforcement component comprises long glass fiber.

41. The method of claim 31, wherein the glass fiber reinforcement component comprises short glass fiber.

42. The method of claim 31, wherein the thermoplastic resin mixture comprises one or more additive selected from the group consisting of a coupling agent, heat stabilizer, flow modifier, stabilizer(s) for improved weathering, and colorant.

43. The method of claim 31, wherein the contacting of step c) comprises coating the glass fiber reinforcement component with the thermoplastic resin mixture.

44. The method of claim 31, wherein the contacting of step c) comprises impregnating the glass fiber reinforcement component with the thermoplastic resin mixture.

45. The method of claim 31, wherein the contacting of step c) is performed by a pultrusion process.

46. The method of claim 31, wherein after the contacting step the provided fiber reinforced thermoplastic composite is in the form of a pellet.

47. The method of claim 31, wherein the provided thermoplastic composite comprises
a) from 10 to 89 weight percent of the polypropylene polymer component;
b) from 1 to 30 weight percent of the low melt flow elastomer component; and
c) from 10 to 70 weight percent of a glass fiber reinforcement component.

48. The method of claim 31, further comprising introducing an additive during or after the contacting step c).

49. The method of claim 48, wherein the additive is introduced during an extrusion molding step.

50. The method of claim 48, wherein the additive comprises a coupling agent, heat stabilizer, flow modifier, stabilizer(s) for improved weathering, colorant, neat polypropylene, or any combination thereof.

51. A method for the manufacture of a fiber reinforced thermoplastic composition, comprising the steps of:
a) providing thermoplastic resin mixture comprising a polypropylene polymer component and an ethylene-butene elastomer component having a melt flow index (MFI) in the range of from 5 to 20 g/10 minutes as measured at a temperature of 190° C. and under 2.16 kg of load;
b) providing a long glass fiber reinforcement component; and
c) contacting the glass fiber reinforcement component with the thermoplastic resin mixture to provide a fiber reinforced thermoplastic composite;
wherein the provide thermoplastic composite comprises: i) from 10 to 89 weight percent of the polypropylene polymer component; ii) from 1 to 30 weight percent of the ethylene-butene elastomer component; and iii) from 10 to 70 weight percent of the long glass fiber reinforcement component.

52. The method of claim 51, wherein the provided fiber reinforced thermoplastic composite exhibits at least about a 10% greater notched izod impact strength than that of a reference composite consisting essentially of substantially the same proportions of the fiber reinforcement component and the polypropylene polymer component in the absence of the same second polypropylene polymer.

53. The method of claim 51, wherein the provided fiber reinforced thermoplastic composite exhibits at least about a 25% greater notched izod impact strength than that of a reference composite consisting essentially of substantially the same proportions of the fiber reinforcement component and the polypropylene polymer component in the absence of the same second polypropylene polymer.

54. The method of claim 51, wherein the provided fiber reinforced thermoplastic composite exhibits at least about a 10% greater unnotched izod impact strength than that of a reference composite consisting essentially of substantially the same proportions of the fiber reinforcement component and the polypropylene polymer component in the absence of the same second polypropylene polymer.

55. The method of claim 51, wherein the provided fiber reinforced thermoplastic composite exhibits at least about a 25% greater unnotched izod impact strength than that of a reference composite consisting essentially of substantially the same proportions of the fiber reinforcement component and the polypropylene polymer component in the absence of the same second polypropylene polymer.
